(19) United States
(12) Patent Application Publication
(10) Pub. No.: US 2015/0160734 A1
(43) Pub. Date: Jun. 11, 2015

(54) Written Data Processing Apparatus

(71) Applicant: Brother Kogyo Kabushiki Kaisha, Nagoya-shi (JP)

(72) Inventor: Yoshihiko Sugimura, Nagoya-shi (JP)

(21) Appl. No.: 14/491,598

(22) Filed: Sep. 19, 2014

(30) Foreign Application Priority Data
Dec. 5, 2013 (JP) 2013-252563

(51) Int. Cl. G06F 3/01; G06F 3/038; G06F 3/0354

(52) U.S. Cl. CPC G06F 3/017; G06F 3/03545; G06F 3/0383

(57) ABSTRACT

A written data processing apparatus digitize a movement trajectory of a writing instrument when the writing instrument is used to write on a located paper medium. The written data processing includes a detection portion and a processor. The detection portion detects a position of the writing instrument. The processor obtains coordinate data corresponding to a position detected by the detection portion and time data and determines whether a first location specified by the obtained coordinate data and a second location within a check region coincide with each other. If the first location and the second location do not coincide, then the coordinate data and the time data are stored in a first storage portion. If the first location and the second location coincide with each other, then save, addition, or deletion processing is selected based on at least one of coordinate data and the time data.

### CROSS-REFERENCE TO RELATED APPLICATION

This application claims priority to Japanese Patent Application No. 2013-252563, filed on Dec. 5, 2013, the disclosure of which is hereby incorporated herein by reference in its entirety.

### BACKGROUND

The present disclosure relates to a written data processing apparatus that is configured to digitize a movement trajectory of writing instrument.

A written data processing apparatus is known in the art that is capable of digitize a movement trajectory of writing instrument as a handwriting according to a writing instrument operation when the writing instrument is used for writing on a paper medium placed on a pedestal. This kind of known apparatus generates stroke data having a plurality of pieces of coordinate information indicating locations of a pen nib when an electronic pen is used for writing on the paper medium placed on a placing unit. A plurality of check boxes corresponding to designation of a holder, save and deletion, respectively, are provided with the paper medium used for the above mentioned apparatus. When a user writes with the electronic pen to check either of a plurality of check boxes, the above mentioned apparatus identifies the checked checkbox based on the location on which the check is written. If the check is written in the checkbox corresponding to designation of a folder and save, then the above mentioned apparatus saves the stroke data in the designated folder. On the other hand, if the check is written in the other checkbox corresponding to deletion, then the above mentioned apparatus deletes the saved stroke data.

### SUMMARY

For the paper medium employed for the above mentioned apparatus, a plurality of check boxes corresponding to designation of the folder, save and deletion, respectively, are provided at different locations on the paper medium. Accordingly, if, for example, larger number of folders to be designated is required or the other processing other than save and deletion is required to be carried out with the above mentioned apparatus by writing the check in the check box, then the required number of check boxes to be provided on the paper medium must further increase. In this case, the smaller a region on which the user freely writes becomes, as the larger the required number of check boxes increases, which entails a drawback of the known apparatus.

Various exemplary embodiments of the general principles described herein provide a written data processing apparatus that is capable of employing a paper medium in which sufficient region is reserved to allow a user to freely write thereon.

Exemplary embodiments herein provide a written data processing apparatus configured to digitize a movement trajectory of a writing instrument when the writing instrument is used for wiring on a placed paper medium. The written data processing apparatus includes a detection portion and a processor. The detection portion is configured to detect a location of the writing instrument in proximity to a prescribed area at which the paper medium is placed. The processor is configured to operate in the following manner. Namely, the processor obtains coordinate data corresponding to a location detected by the detecting unit, and obtains time data corresponding to time when the coordinate data is obtained. The processor determines whether a first location and a second location coincide with each other. The first location is specified by the obtained coordinate data. The second location is within a check region. The check region is at least one region determined based on a type of the paper medium out of the prescribed regions. If the processor determines that the first location and the second location do not coincide, then the processor stores the coordinate data and the time data in a first storage portion. If the processor determines that the first location and the second location coincide with each other, then the processor selects either of save processing, addition processing and deletion processing based on at least one of coordinate data and the time data. When the save processing is selected, the processor creates a first image file and stores the created first image file in a second storage portion. The first image file includes a dot or a line drawing indicated by the coordinate data stored in the first storage portion. When the addition processing is selected, the processor creates a second image file. The second image file includes a dot or a line drawing indicated by the coordinate data corresponding to the first image file stored in the second storage portion, and a dot or a line drawing indicated by the coordinate data stored in the first storage portion. Further, when the addition processing is selected, the processor stores the created second image file in the second storage portion as the first image file. When the deletion processing is selected, the processor deletes the first image file from the second storage portion.

Exemplary embodiments herein also provide a written data processing apparatus configured to digitize a movement trajectory of a writing instrument when the writing instrument is used for wiring on a placed paper medium. The written data processing apparatus includes a detection portion and a processor. The detection portion is configured to detect a location of the writing instrument in proximity to a prescribed area at which the paper medium is placed. The processor is configured to operate in the following manner. Namely, the processor obtains coordinate data corresponding to a location detected by the detecting unit, and obtains time data corresponding to time when the coordinate data is obtained. The processor determines whether a first location and a second location coincide with each other. The first location is specified by the obtained coordinate data. The second location is within a check region. The check region is at least one region determined based on a type of the paper medium out of the prescribed regions. If the processor determines that the first location and the second location do not coincide, then the processor stores the coordinate data and the time data in a first storage portion. If the processor determines that the first location and the second location coincide with each other, then the processor selects either of save processing, addition processing and deletion processing based on at least one of coordinate data and the time data. When the save processing is selected, the processor creates first stroke data based on the coordinate data stored in the first storage portion, and stores the created first stroke data in a second storage portion. When the addition processing is selected, the processor creates second stroke data based on the coordinate data corresponding to the first stroke data stored in the second storage portion and the coordinate data stored in the first storage portion. Further, when the addition processing is selected, the processor stores the created second stroke data as the first stroke data in the second storage portion. When the deletion processing is selected, the processor deletes the first stroke data from the second storage portion.

### BRIEF DESCRIPTION OF THE DRAWINGS

Embodiments will be described below in detail with reference to the accompanying drawings in which:

FIG. 1 is a perspective view of a handwriting input system according to one embodiment of the present invention.

FIG. 2 is a block diagram illustrating an electric configuration of a reading device and a smartphone.

FIG. 3 is a view illustrating a paper form.

FIG. 4 is a view illustrating a table.

FIG. 5 is a schematic view illustrating a handwriting procedure.

FIG. 6 illustrates a flowchart of main processing.

FIG. 7 illustrates another flowchart of main processing following the processing of FIG. 6.

FIG. 8 illustrates a flowchart of selection processing.

FIG. 9 illustrates a flowchart of another selection processing according to a first modification to the embodiment of the present invention.

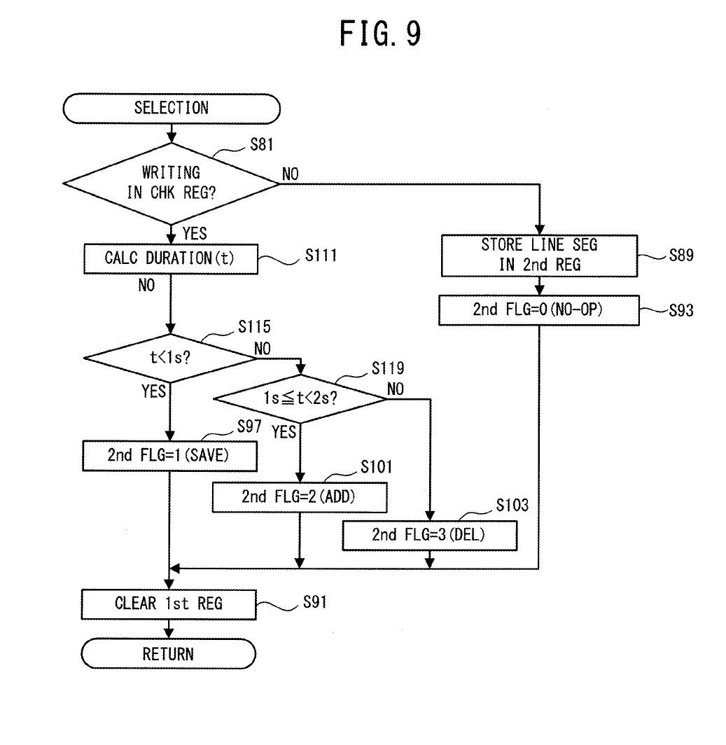

FIG. 10 illustrates a flowchart of yet another selection processing according to a second modification to the embodiment of the present invention.

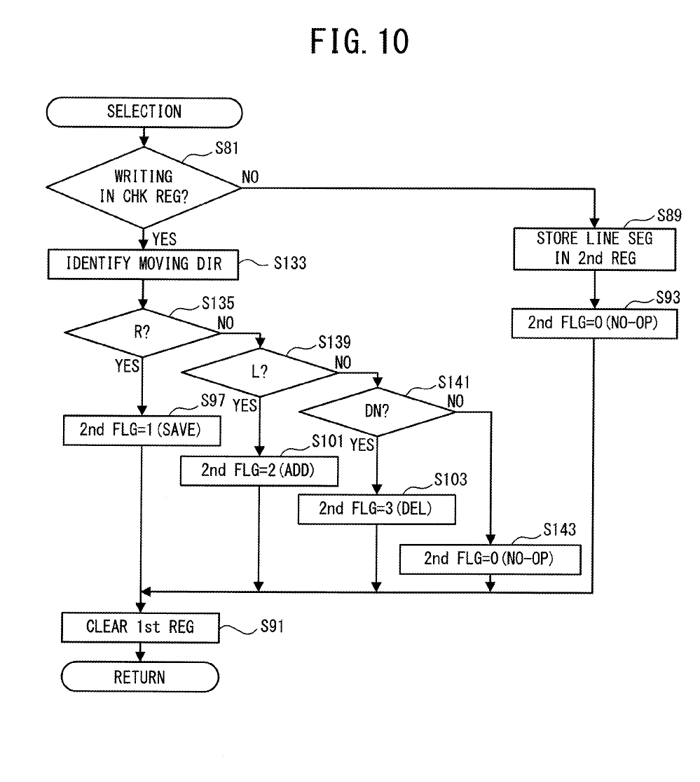

### DETAILED DESCRIPTION

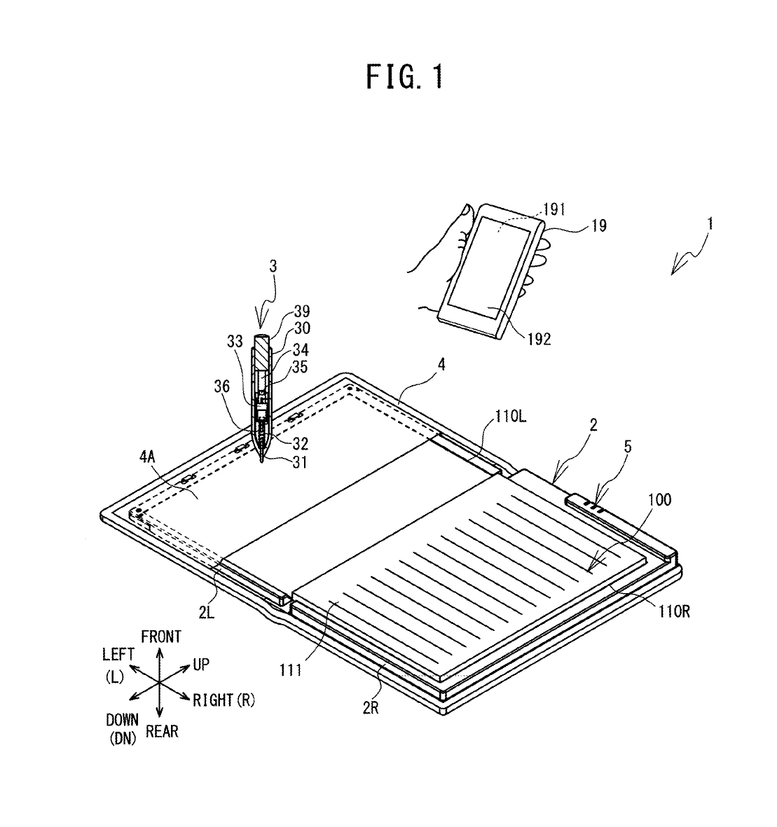

Now, embodiments of the present invention will be described with reference to the drawings. Referring first to FIG. 1, a general outline of a handwriting input system 1 according to the present embodiment will be described. Hereinafter, a geometry and an orientation is defined as follows. Namely, upper left side, lower right side, upper side, lower side, upper right side and lower left side in FIG. 1 corresponds to left side, right side, front side, rear side, upper side and lower side of a reading device 2, respectively.

As shown in FIG. 1, the handwriting input system 1 mainly includes the reading device 2, an electronic pen 3 and a smartphone 19 or the like. The reading device 2 is a handwriting entry device which is foldable, portable, thin and lightweight. With the handwriting input system 1, a user, using the electronic pen 3, writes a dot or a line drawing on a paper medium 100 (paper form 111) mounted in the reading device 2. Hereinafter, a case will be described where a line drawing is written. The line drawing may include a character, a numeral, a symbol, a graphic, and/or the like. The reading device 2 identify a location of the electronic pen 3 during the course of the writing. The reading device 2, based on the obtained location, identifies the written line drawing on the paper form 111 with the electronic pen 3. The reading device 2 then creates an image file of an image containing the identified line drawing. The reading device 2 is capable of transmitting the created image file to the smartphone 19. The smartphone 19, when the image file is received, allows a display 192 to display the image corresponding to the received image file. Thus, the user can visually recognize the line drawing of the same shape as the line drawing written on the paper form 111 with the electronic pen 3.

The reading device 2 is mainly configured with a symmetrical pair of a left reading device 2L, a right reading device 2R, and a cover 4. The left reading device 2L and the right reading device 2R are of rectangular and thin plate-like shape. The left reading device 2L and the right reading device 2R are arranged in double page spread manner at the front face of the cover 4 in the left and right directions. The left reading device 2L and the right reading device 2R are electrically connected each other via a flat cable (not shown). The right reading device 2R is provided with three LEDs 5 at the upper end. The LEDs 5 are capable of notifying the user of a status of the reading device 2. The cover 4 is provided with a bag portion 4A formed in a bag-like (sac-like) shape at left side. The left reading device 2L is inserted into the bag portion 4A so that the left reading device 2L is detachably mounted to the cover 4. The right reading device 2R is affixed to the right front face of the cover 4 with a double sided adhesive tape or the like.

A paper medium 100 is detachably mounted at the front face of the reading device 2. The paper medium 100 is a booklet being double page spread in the left and right directions. In the paper medium 100, a pair of covers (i.e., a front cover 110L and a back cover 110R) and a plurality of paper forms 111 are bound at a part of respective edge portions. For example, the paper medium 100 is a notebook of A5 size. A format showing a pattern layout and the like, wherein the pattern layout is a layout of pre-printed patterns on the paper form 111, varies by the type of the paper medium 100. Further, the format of the paper form 111 may vary by page. Hereinafter, the pattern pre-printed on the paper form 111 is referred to as a “print pattern”. The print medium 100 is mounted to the reading device 2 such that the front cover 110L is placed on the front face of the left reading device 2L and the back cover 110R is placed on the front face of the right reading device 2R. In the present embodiment, the paper medium 100 is mounted such that the paper medium 100 is positioned in the reading device 2 with the double sided adhesive tape or the like. In other words, the left reading device 2L and the right reading device 2R integrally travel with the front cover 110L and the back cover 110R, respectively. The user is capable of writing the line drawing on the paper form 111 of the paper medium 100 with the electronic pen 3.

It should be noted that the reading device 2 may be configured only with the right reading device 2R. In this case, a writing block of A5 size may be employed as exemplary paper medium 100 which is mountable to the reading device 2.

The electronic pen 3 is an electromagnetic knock type electronic pen, and mainly includes a cylindrical body 30, a core body 31, a coil 32, a variable capacitance capacitor 33, a board 34, a capacitor 35, an ink storage unit 36 and a knock cam (not shown). The cylindrical body 30 is of a cylindrical shape and houses the core body 31, the coil 32, the variable capacitance capacitor 33, the board 34, the capacitor 35 and the ink storage unit 36 in the interior thereof. The core body 31 extends within the cylindrical body 30 along the extending direction of the cylindrical body 30. One end of the core body 31 is arranged at the tip end of the electronic pen 3, and the other end of the core body 31 is connected to the ink storage unit 36 containing the ink. The ink storage unit 36 supplies the ink to the core body 31. The core body 31 is biased towards the tip end of the electronic pen 3 with an elastic member (not shown).

The knock cam includes a cam body (not shown), a knock rod 39 and a rotor (not shown). The cam body is provided on an inner wall of a distal end of the cylindrical body 30, at an opposite side to the tip end of the electronic pen 3. The knock rod 39 protrudes outwardly from above mentioned the distal end of cylindrical body 30. The rotor is connected to the core body 31. When the knock rod 39 is pressed into the inside of the cylindrical body 30, the rotor rotates to engage a part of tip end of the electronic pen 3 in the cam body. The core body 31 moves towards the tip end of the electronic pen 3 against the biased force of the elastic member. One end of the core body 31 is hold by the cam body such that the one end of the core body 31 protrudes outwardly from the cylindrical body 30. When the user uses the electronic pen 3 for writing on the paper form 111 with the one end of the core body 31 being protruding outwardly from the cylindrical body 30, then a line drawing is formed on the paper form 111 by ink. When the knock rod 39 is again pressed into the inside of the cylindrical body 30, the rotor further rotates. Thus, the engagement is released between the rotor and the part of the tip end of the electronic pen 3 in the cam body. Then, the core body 31 moves to the opposite side of the electronic pen 3 with the biased force of the elastic member, and the one end of the core body 31 is housed within the cylindrical body 30.

The coil 32 is hold between the core body 31 and the variable capacitance capacitor 33, with the coil 32 being wound around the ink storage unit 36. The variable capacitance capacitor 33 is secured to the inside of the electronic pen 3 with the board 34. The capacitor 35 is mounted on the board 34. The capacitor 35 and the variable capacitance capacitor 33 are connected to the coil 32 in parallel to constitute a well known resonance (tuned) circuit.

A smartphone 19 is provided with a touch panel 191 and a display 192. The touch panel 191 is used for inputting a various instruction. The display 192 is capable of displaying an image corresponding to an image file. It should be noted that a general purpose personal computer or a tablet personal computer may be employed in place of the smartphone 19.

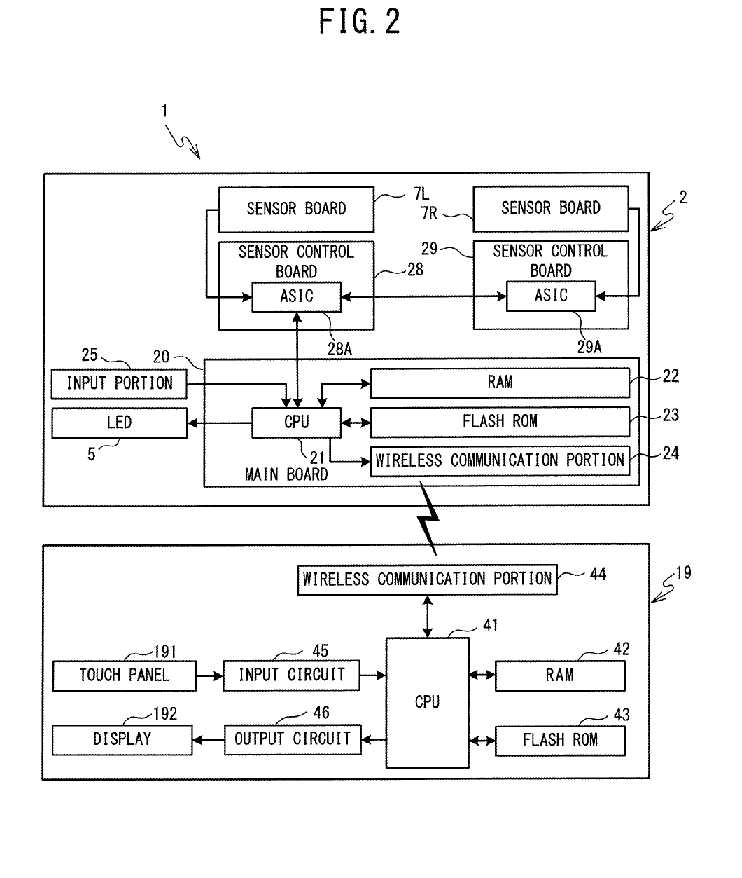

Referring to FIG. 2, an electronic configuration of the handwriting input system 1 will be described below. First, an electronic configuration of the reading device 2 and an outline of a principle that the reading device 2 detects coordinate data will be described. The reading device 2 is provided with sensor boards 7L and 7R, a main board 20, sensor control boards 28 and 29, an input portion 25 and three LEDs 5. The sensor boards 7L and 7R are disposed in the left reading device 2L and the right reading device 2R, respectively. The input portion 25 and the three LEDs 5 are disposed in the right reading device 2R.

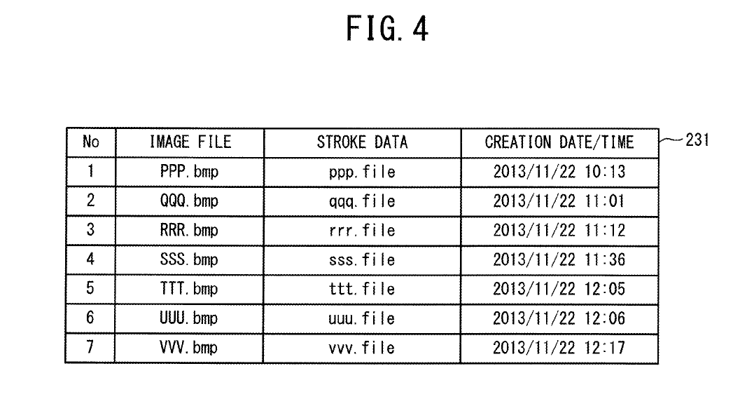

The main board 20 is provided with a CPU 21, a RAM 22, a flash ROM 23 and a wireless communication portion 24. The RAM 22, the flash ROM 23 and the wireless communication portion 24 are electrically connected to the CPU 21. The CPU 21 controls the reading device 2. The RAM 22 stores various data such as arithmetic data on a temporary basis. The flash ROM 23 stores a program to be carried out the by the CPU 21 for controlling the reading device 2. In addition, the flash ROM 23 stores a table 231 (see, FIG. 4) which will be described hereinafter. The flash ROM 23 also stores a plurality of pieces of layout data each of which corresponds to a format of the paper form 111. The wireless communication portion 24 is a controller that carries out a near field wireless communication with an external electronic device. The input portion 25 and the three LEDs 5 are electrically connected to the CPU 21. The input portion 25 is a switch for inputting an instruction to the reading device 2. The colors of the three LEDs 5 are yellow, green and red, respectively.

At the sensor boards 7L and 7R, a lot of elongated loop coil are arranged in the vertical and horizontal direction, respectively. The sensor board 7L is connected to an ASIC 28A of the sensor controlling board 28. The ASIC 28A, when a writing operation with the electronic pen 3 is conducted on the sensor board 7L, detects coordinate data indicating a position of the electronic pen 3. The sensor board 7R is connected to an ASIC 29A of the sensor controlling board 29. The ASIC 29A, when a writing operation with the electronic pen 3 is conducted on the sensor board 7R, detects coordinate data indicating a position of the electronic pen 3. Out of ASICs 28A and 29A, the ASIC 28A at the master side is directly connected to the CPU 21, and the ASIC 29A at the slave side is connected to the CPU 21 through the ASIC 28A.

A principle where coordinate data is detected when a writing operation with the electronic pen 3 is conducted on the sensor boards 7L and 7R will be described below. The CPU 21 controls the ASICs 28A and 29A to apply current at prescribed frequency (i.e., transmission current for excitation) to each of the loop coils of the sensor boards 7L and 7R. It causes the each of the loop coils of the sensor boards 7L and 7R to generate a magnetic field. In this situation, if, for example, the user uses the electronic pen 3 to conduct a writing operation writing a line drawing on the paper form 111 of the paper medium 100 located in the reading device 2, the electronic pen 3 approaches to the sensor boards 7L and 7R. Accordingly, the resonance circuit of the electronic pen 3 resonates by the electromagnetic induction to generate an induction field.

Next, the CPU 21 controls the ASICs 28A and 29A to stop the each of the loop coils of the sensor boards 7L and 7R to generate the magnetic field. The each of the loop coils of the sensor board 7L and 7R receives the induction field generated from the resonance circuit of the electronic pen 3. The CPU 21 controls the ASICs 28A and 29A to allow the ASICs 28A and 29A to detect signal current (i.e., induction current) flowing in the each of loop coils of the sensor board 7L and 7R. The ASICs 28A and 29A repeats carrying out such operation for each of all loop coils one by one to detect the induction current so that coordinate data indicating the position of the electronic pen 3 is detected. The CPU 21, when the induction current is greater than the prescribe value, determines that the line drawing is written with the electronic pen 3 being contacting the paper form 111.

It should be noted that a method of detecting the position of the electronic pen 3 in the above embodiment may change to employ another method. For example, the reading device 2 may include a touch panel on an upper surface. In this case, the position written by the electronic pen 3 corresponds to the position on which the touch panel is pressed. Accordingly, the CPU 21 of the reading device 2 is capable of obtaining coordinate data indicating the position on which the touch panel is pressed from the touch panel.

Further, the CPU 21 may identify a writing pressure applied to the electronic pen 3. More particularly, such alternative method will be described below. The writing pressure is applied to the core body 31 during the operation of the electronic pen 3 writing a line drawing on the paper form 111. The inductance of the coil 32 varies depending on the writing pressure applied to the core body 31. Thus, the resonance frequency of the resonance circuit of the electronic pen 3 changes depending on the writing pressure applied to the core body 31. The CPU 21 may detect the change in the resonance frequency (phase variation) to identify the writing pressure applied to the electronic pen 3. In other words, the CPU 21 may determine with the identified writing pressure whether the device is in the status that the line drawing is written on the paper form 111 of the paper medium 100.

Next, an electronic configuration of the smartphone 19 will be described below. The smartphone 19 mainly includes a CPU 41, a RAM 42, a flash ROM 43, a wireless communication portion 44, an input circuit 45, an output circuit 46, a touch panel 191 and a display 192. The CPU 41 controls the smartphone 19. The CPU 41 is electrically connected to the RAM 42, the flash ROM 43, the wireless communication portion 44, the input circuit 45 and the output circuit 46.

The RAM 42 stores various temporary data. The wireless communication portion 44 is a controller that carries out a near field wireless communication with an external electronic device. The input circuit 45 controls to send an instruction from the touch panel 191 to the CPU 41. The output circuit 46 controls to allow the display 192 to display an image in response to the instruction from the CPU 41.

The flash ROM 43 stores a program carried by the CPU 41 and an image file received from the reading device 2. The smartphone 19 is provided with a medium reading device such as a memory card slot (not shown). The smartphone 19 is capable of reading with the medium reading device a program stored in a recording medium such as a memory card to install the program into the flash ROM 43. Alternatively, the smartphone 19 may receive a program with an external equipment (not shown) connected to the smartphone 19 or through a network to install the program into the flash ROM 43.

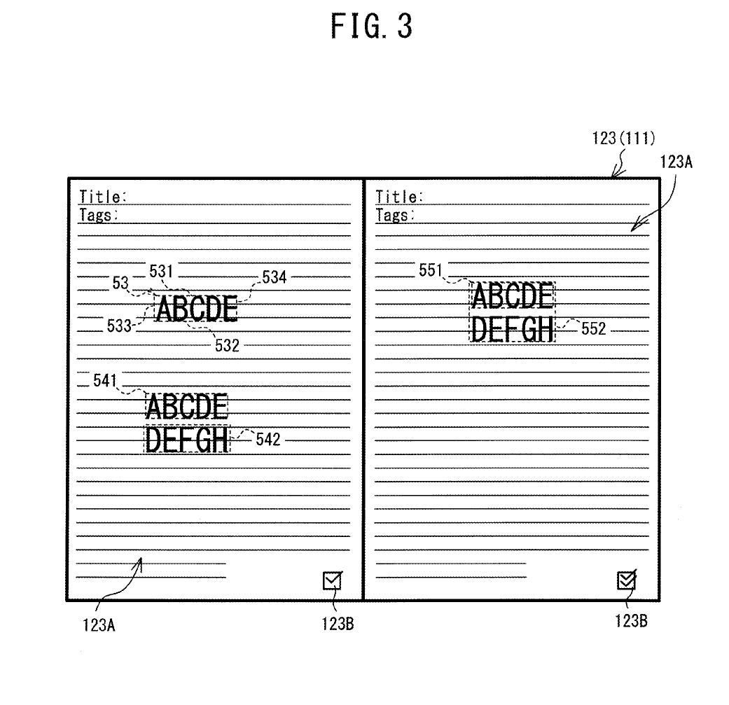

Referring to FIG. 3, a paper form 123 as an exemplary paper form 111 of the paper medium 100 will be described. Hereinafter, a geometry and an orientation is defined as follows. Namely, left side, right side, upper side and lower side in FIG. 3 corresponds to left side, right side, upper side and lower side of the paper form 111, respectively. It should be noted that FIG. 3 shows a two-page paper form 123 facing each other when the paper medium 100 is in a spread state.

As shown in FIG. 3, the paper form 123 is memo pad for wiring a memo. The paper form 123 includes a fillable entry region 123A and a check box 123B. The fillable entry region 123A is a region in which a user writes memo. In the fillable entry region 123A, a plurality of ruled lines extending in the horizontal direction are printed such that the ruled lines are arranged in the vertical direction at regular intervals. At upper left side of each of two ruled line at upper end, characters “Title:” and “Tags:” are printed. The check box 123B is a region in which the user writes a line drawing in order to confirm the written line drawing in the fillable entry region 123A. The check box 123B is printed at lower right side of the fillable entry region 123A. The check box 123B is of rectangular shape with single line.

It should be noted that the paper form 111 employable for the reading device 2 is not limited to the paper form 123 in FIG. 3 and may be another paper form 111 in another format. The check box 123B may change its shape and position. For example, the check box 123B may be of circular shape. The check box 123B may be provided at either of upper left, lower left and upper right of the fillable entry region 123A.

Referring to FIGS. 3 to 5, an outline of processing of the CPU 21 will be described when an image file is created based on a line drawing written in the paper form 123. The CPU 21 of the reading device 2 controls the ASICs 28A and 29A to select each of a plurality of loop coils one by one. The CPU 21 causes current to flow through the selected loop coil and then to be cut off. At this moment, if the generated induction current is greater than a prescribed value in the loop coil, then it is determined that the electronic pen 3 is approaching to the loop coil in which the induction current is generated. The CPU 21, when it detects through the ASICs 28A and 29A that the induction current greater than the prescribe value is generated in the loop coil, determines that a writing operation is being conducted with the electronic pen 3. The CPU 21 obtains coordinate data indicating a position of the loop coil in which the induction current greater than the prescribed value is generated. The CPU 21 then associates the obtained coordinate data with time data indicating time when the coordinate data is obtained, and stores them in the first storage region of the RAM 22.

On the other hand, when the electronic pen 3 is apart from the loop coil, the induction current greater than the prescribed value is not generated in the loop coil. Accordingly, the CPU 21, when the induction current greater than the prescribed value is generated in none of loop coils, determines that a writing operation is not being conducted with the electronic pen 3. A plurality of pieces of coordinate data and a plurality of pieces of time data stored in the first region in the RAM 22 during time from the writing operation is determined to be conducted with the electronic pen 3 until the writing operation is determined not to be conducted any more, indicate a position of one line segment constituting a line drawing written in the paper form 123 with the electronic pen 3. Hereinafter, a plurality of pieces of coordinate data indicating a position of one line segment and a plurality of pieces of time data each associated with each of the plurality of pieces of coordinate data are collectively referred to as “line segment data.”

Although the present embodiment describes a case where a writing operation writing a line segment is conducted with the electronic pen 3, it may be another case where a writing operation writing dot is conducted with the electronic pen 3, that is, a writing operation is conducted that the electronic pen 3 is instantly placed on the paper form 123. In this case, in the first region in the RAM 22, one piece of coordinate data corresponding to the written dot and one piece of associated time data are stored as the line segment data.

The CPU 21, based on the line segment data stored in the first region in the RAM 22, determines whether the line drawing is written either in the fillable entry region 123A of the paper form 123 or in the check box 123B thereof. The CPU 21, when the line drawing is determined to be written in the fillable entry region 123A, stores in the second region in the RAM 22 the line segment data stored in the first region in the RAM 22, and clears the first region in the RAM 22. Every time the user writes one line segment in the fillable entry region 123A with the electronic pen 3, the line segment data is stored in the second region in the RAM 22 in serial.

The CPU 21, when the line drawing is determined to be written in the check box 123B, creates stroke data including at least one piece of line segment data stored in the second region in the RAM 22. The stroke data includes at least one piece of line segment data obtained during time from the line drawing is written in the check box 123B until another line drawing is written in the check box 123B next time. Next, the CPU 21 extracts each of at least one piece of line segment data included in the created stroke data one by one. The CPU 21 connects a plurality of positions indicated by a plurality of pieces of coordinate data corresponding to the extracted line segment data with straight lines to join one another in the order of time indicated by a plurality of pieces of associated time data. The CPU 21 joins the line segments each of which is obtained for each of line segment data and identifies as a line drawing. The CPU 21 creates an image file of an image containing only proximity of identified line drawing. The image file is a data file that indicates the line drawing in a digital image. Exemplary digital images are, for example, a vector image and a raster image. As such, exemplary image files are, for example, a JPEG file, a GIF file, a PNG file and a BMP file.

More specific examples will be described below. As shown in FIG. 3, the case will be exemplarily described where the electronic pen 3 writes a character string “ABCDE” (in the square 53) in the fillable entry region 123A of the paper form 123 and then writes a line drawing in the check box 123B. In this case, the CPU 21 identifies positions of each of uppermost side, lowermost side, leftmost side and rightmost side of the written character string “ABCDE”. In other words, the CPU 21 identifies a square 53 enclosed by a straight line 531 passing the uppermost position and horizontally extending, a straight line 532 passing the lowermost position and horizontally extending, a straight line 533 passing the leftmost position and vertically extending, and a straight line 534 passing the rightmost position and vertically extending. The CPU 21 creates an image file of an image indicating the enclosed region by the identified by the square 53.

The CPU 21 stores the created image file in a table 231 in FIG. 4. In addition, the CPU 21 associates the stored image file with the stroke data used as of creation of the image file and a creation date and time of the image file, then stores them in the table 231.

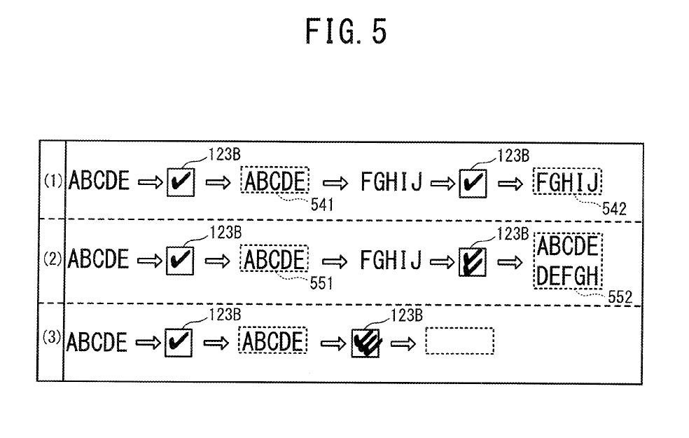

Referring now to FIG. 5, writing procedure will be described. A character string “ABCDE” is written in the fillable entry region 123A of the paper form 123 (see the square 541 in FIG. 3). In this case, the CPU 21 stores a plurality of pieces of line segment data corresponding to the character string “ABCDE” in the second region in the RAM 22. Subsequently, one check mark is written in the check box 123B. In this case, the CPU 21 creates stroke data containing a plurality of pieces of line segment data stored in the second region in the RAM 22. The CPU 21, based on the created stroke data, creates an image file of an image indicating an enclosed region by the square 541 containing the character string “ABCDE.” The CPU 21 associates the created image file with the stroke data and the creation date and time to store them in the table 231 (see FIG. 4). Hereinafter, a unit consisting of the image file, the stroke data and the creation date and time associated with one another and stored in the table 231 are referred to as a “record.” The CPU 21 stores a record corresponding to the character string “ABCDE” in the table 231, and then deletes a plurality of pieces of line segment data corresponding to the character string “ABCDE” from the second region in the RAM 22.

Subsequently, a character string “FGHIJ” is written below the written portion of the character string “ABCDE” in the fillable entry region 123A of the paper form 123 (see, the square 542 in FIG. 3). In this case, the CPU 21 stores a plurality of pieces of line segment data corresponding to the character string “FGHIJ” in the second region in the RAM 22. At this moment, a plurality of pieces of line segment data corresponding to the character string “ABCDE” has been already deleted from the second region in the RAM 22. Thus, at this moment, the second region of the RAM 22 stores only a plurality of pieces of line segment data corresponding to the character string “FGHIJ”. Subsequently, one check mark is written in the check box 123B. In this case, the CPU 21 creates stroke data containing a plurality of pieces of line segment data stored in the second region in the RAM 22. The CPU 21, based on the created stroke data, creates an image file of an image indicating an enclosed region by the square 542 containing the character string “FGHIJ”. The CPU 21 associates the created image file with the stroke data and the creation date and time to store them in the table 231 (see, FIG. 4). Hereinafter, the procedure shown in (1) of FIG. 5 is referred to as the “save processing.”

On the other hand, when two or three check marks are written in the check box 123B, the CPU 21 carries out the different procedure other than the above mentioned procedure, which will be described hereinafter. First, referring to (2) of FIG. 5, the case will be described in detail where two check marks are written in the check box 123B. The procedure by the CPU 21 from when the character string “ABCDE” is written in the fillable entry region 123A (see, in the square 551 in FIG. 3) then one check mark is written in the check box 123B until when the character string “FGHIJ” is written in the fillable entry region 123A (see, in square 552 in FIG. 3) is the same as the one in (1) of FIG. 5, therefore a duplicable explanation will be omitted.

Next, two check marks are written with the electronic pen 3 in the check box 123B. In this case, the CPU 21 stores in the second region in the RAM 22 a plurality of pieces of line segment data contained in the stroke data of which a creation date and time is the newest (latest) in the table 231. In the case of (2) in FIG. 5, the character string “ABCDE” has been written, immediately before two check mark are written in the check box 123B. Thus, a plurality of line segment data contained in the stroke data in the record corresponding to the character string “ABCDE” are stored in the second region in the RAM 22. Writing one check mark in the check box 123B causes the line segment data corresponding to the character string “ABCDE” once deleted from the second region in the RAM 22 to be stored again in the second region in the RAM 22. At this moment, a plurality of pieces of line segment data corresponding to the character string “FGHIJ” are stored in the second region in the RAM 22. Thus, writing two check marks in the check box 123B causes a plurality of line segment data corresponding to the character strings “ABCDE” and “FGHIJ” to be stored in the second region in the RAM 22. Subsequently, the CPU 21 deletes a record of the newest creation date and time in the table 231, namely a record corresponding to the character string “ABCDE.” Accordingly, the table 231 returns to the state before one check mark is written in the check box 123B.

Subsequently, the CPU 21 creates stroke data containing a plurality of pieces of line segment data stored in the second region in the RAM 22. The CPU 21, based on the created stroke data, creates an image file of an image indicating an enclosed region by the square 552 containing the character strings “ABCDE” and “FGHIJ”. The CPU 21 associates the created image file with the stroke data corresponding to the character strings “ABCDE” and “FGHIJ” and the creation date and time thereof to store them in the table 231. The CPU 21 stores records corresponding to the character strings “ABCDE” and “FGHIJ”, respectively, in the table 231, and then deletes from the second region in the RAM 22 a plurality of pieces of line segment data corresponding to the character strings “ABCDE” and “FGHIJ.” Hereinafter, the processing shown in (2) of FIG. 5 is referred to as the “addition processing.”

As described above, the CPU 21, in response to the writing of two check marks being made in the check box 123B, deletes from the table 231 the image file of the image containing the character string “ABCDE.” A plurality of pieces of line segment data corresponding to the character string “ABCDE” are again stored in the second region in the RAM 22. The CPU 21, based on a plurality of pieces of line segment data stored in the second region in the RAM 22, creates again the stroke data and the image file. Thus, if a plurality of pieces of line segment data corresponding to another character string “FGHIJ” are stored in the second region in the RAM 22 when a plurality of pieces of line segment data corresponding to the character string “ABCDE” are again stored in the second region in the RAM 22, then the CPU 21 is capable of newly creating image files containing character strings “ABCDE” and “FGHIJ.” Accordingly, image files of images containing character strings “ABCDE” and “FGHIJ” are stored in the table 231. Writing two check marks in the check box 123B corresponds to an instruction by a user directed to the reading device 2 that instructs to add another character string to the previous character string of which image file is once created to newly create an image file.

Next, referring to (3) of FIG. 5, the case will be described in detail where three check marks are written in the check box 123B. The procedure by the CPU 21 from when the character string “ABCDE” is written in the fillable entry region 123A (see, in the square 551 in FIG. 3) until when one check mark is written in the check box 123B is the same as the one in (1) and (2) of FIG. 5, therefore a duplicable explanation will be omitted. Next, three check marks are written with the electronic pen 3 in the check box 123B. In this case, the CPU 21 deletes a record of which creation date and time is the newest in the table 231, namely a record corresponding to the character string “ABCDE.” Hereinafter, a procedure shown in (3) of FIG. 5 is referred to as the “deletion processing.”

As described above, the CPU 21, in response to the writing of three check marks in the check box 123B, deletes from the table 231 the image file of the image containing the character string “ABCDE.” Writing three check marks in the check box 123B corresponds to an instruction by a user directed to the reading device 2 that instructs to delete the created image file.

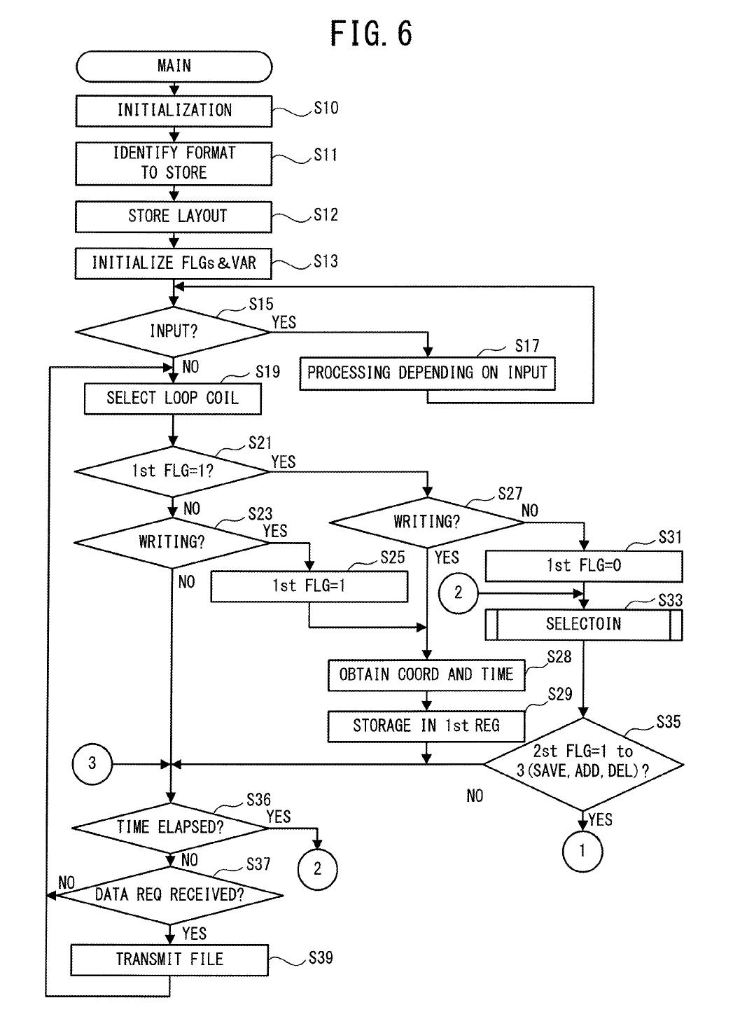

Referring to FIGS. 6 to 8, a main processing carried out by the CPU 21 of the reading device 2 will be described. The CPU 21, when the reading device 2 is turned on, operates according to a program stored in the flash ROM 23 to start the main processing.

First, the CPU 21 carries out the following initialization processing (S10). In the initialization processing, the CPU 21 clears data stored in the RAM 22. The CPU 21 then starts to control the ASICs 28A and 29A. Thus, the CPU 21 is brought into a state that the CPU 21 is capable to determine whether a line drawing is written with the electronic pen 3 on the paper form 111 of the paper medium 100 mounted in the reading device 2. The CPU 21, when it is determined that the line drawing is written with the electronic pen 3, is brought into a state that the CPU 21 is capable to obtain coordinate data indicating a position of the electronic pen 3.

The CPU 21 identifies a format of the paper form 111 of the paper medium 100 mounted in the reading device 2 (S11). More particularly, the CPU 21 identifies the format in the following manner. The CPU 21 first allows the red LED 5 to light up red in order to notify a user that a format of the paper form 111 is not yet identified. Then the user writes a line drawing with the electronic pen 3 in the order corresponding to the format of the paper form 111 at a position of a plurality of calibration marks (not shown) printed at the corner of the paper form 111. The CPU 21 obtains a plurality of pieces of coordinate data indicating positions of written line drawing in series, and identifies positions and orders of written line drawings. The CPU 21 then identifies a format of the paper form 111 corresponding to the identified position and order.

The CPU 21 stores format information indicating a format of identified paper form 111 in the RAM 22 (S11). The CPU 21 allows the green LED 5 to light up green in order to notify a user that a format of the paper form 111 is now identified. Hereinafter, an exemplary case will be described where the paper form 123 (see, FIG. 3) is mounted in the reading device 2 and a format of the paper form 123 is identified.

The CPU 21 reads out layout data from the flash ROM 23 and stores the layout data in the RAM 22. The layout data is data that is information corresponding to the identified format and that allows to identify each position of the fillable entry region 123A and the check box 123B of the paper form 123. The CPU 21, based on the layout data stored in the RAM 22 in S12, identifies a portion corresponding to the check box 123B out of regions in which the paper form 123 is mounted (namely, a front face region of the reading device 2). Hereinafter, the front face region of the reading device 2 corresponding to the rectangular region constituting the check box 123B is referred to as a “check region.” Next, the CPU 21 stores “0” in flags stored in the RAM 22 (i.e., a first flag and a second flag) and variable (i.e., variable N) to initialize these flags and the variable (S13).

The CPU 21 determines whether an input operation in the input portion 25 is detected (S15). The CPU 21, when it is determined that the input operation is detected in the input portion 25 (S15: YES), identifies a content of a processing corresponding to the detected input operation. Specific examples of such processing are a restart processing when an error occurs and re-identifying processing of the format of the paper form 111 or the like. The CPU 21, according to the identified content of the processing, carries out the prescribed processing (S17). The CPU 21, after carrying out the processing of S17, returns the processing in S15.

The CPU 21, when it is determined that the input operation is not detected to the input portion 25 (S25:NO), selects one of a plurality of loop coils arranged in the sensor boards 7L and 7R in series (S19). The CPU 21 controls the ASICs 28A and 29A to apply current at prescribed frequency to the selected loop coil. It causes the loop coil to generate the magnetic field. Next, the CPU 21 controls the ASICs 28A and 29A to have the selected loop coil stopped to generate the magnetic field. As described above, after the CPU 21 causes stopping the generation of the magnetic field from the loop coil, the CPU 21 determines that the writing operation with the electronic pen 3 is being conducted if the CPU 21 detects the induction current equal to or greater than the prescribed value flows at the selected loop coil. In this case, the CPU 21 is capable of obtaining the coordinate data indicating a position of the loop coil at which the induction current is generated. On the other hand, the CPU 21 determines that the writing operation with the electronic pen 3 is not being conducted if the CPU 21 detects the induction current equal to or greater than the prescribed value does not flow at the selected loop coil. In this case, the CPU 21 does not obtain the coordinate data.

The CPU 21 determines whether the first flag stores “1” (S21). As described hereinafter, when it is determined that the writing operation with the electronic pen 3 is being conducted, then the value “1” indicating the writing operation is being conducted is stored in the first flag (see, S25). On the other hand, when it is determined that the writing operation with the electronic pen 3 is not being conducted, then the value “0” indicating the writing operation be not being conducted is stored in the first flag (see, S31). It should be noted that in the state immediately after the first flag is initialized in the processing in S13, the first flag stores “0” (S21: NO). In this case, the CPU 21 advances the processing to S23.

The CPU 21 determines whether the writing operation with the electronic pen 3 is being conducted by determining whether the induction current applied to the loop coil is equal to or greater than the prescribed value (S23). The CPU 21, when it is determined that the writing operation is being conducted (S23: YES), stores “1” in the first flag (S25) and obtains the coordinate data (S28). In addition, the CPU 21 obtains the time data indicating time when the coordinate data is obtained (S28). Furthermore, the CPU 21 associates the coordinate data with the time data to store them in the first region in the RAM 22 (S29). Subsequently, the CPU 21 advances the processing to S36. On the other hand, the CPU 21, when the induction current applied to the loop coil is less than the prescribed value, determines that the writing operation with the electronic pen 3 is not being conducted (S23: NO), and advances the processing to S36.

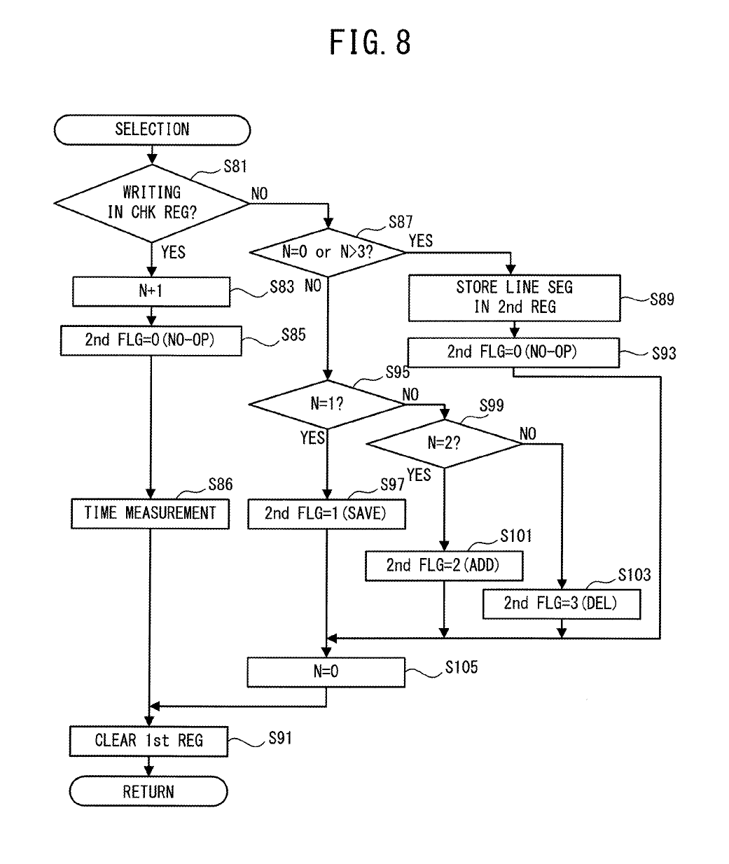

The CPU 21 determines whether the elapsed time from the start of time monitoring in the processing, which will be described hereinafter (see, FIG. 8), is equal to or greater than the prescribed time (S36). The elapsed time indicates time elapsed from time one line segment was written last time in the check box 123B. The CPU 21, when it is determined that the condition that the prescribed time elapses is not yet satisfied (S36: NO), advances the processing to S37.

The CPU 21 determines whether a data requesting command wirelessly transmitted from the smartphone 19 is received via the wireless communication portion 24 (S37). The CPU 21, when the data requesting command is determined not to be received (S37: NO), returns to the processing in S19.

The CPU 21 selects next the loop coil (S19). The CPU 21, when it is determined that the writing operation with the electronic pen 3 is being conducted in the processing in S23 (see, S23: YES), determines that the first flag stores “1” (S21: YES). In this case, the CPU 21 determines whether the writing operation with the electronic pen 3 is ongoing by determining the induction current applied to the loop coil is equal to or greater than the prescribed value (S27). The CPU 21, when it is determined that the writing operation is ongoing (S27: YES), obtains the coordinate data (S28), and associates the coordinate data with the time data to store them in the first region in the RAM 22 (S29). On the other hand, the CPU 21, when the induction current applied to the loop coil is less than the prescribed value, determines the writing operation with the electronic pen 3 has finished (S27: NO). In this case, the CPU 21 stores “0” in the first flag (S31).

As described above, while the first flag is storing “1”, the coordinate data and the time data are repeatedly stored in the first region in the RAM 22 by the processing in S29. Therefore, at this moment, the first region in the RAM 22 is brought into the state that the first region stores a plurality of pieces of coordinate data and a plurality of pieces of time data both of which correspond to one line segment written from the start to the completion of the writing operation with the electronic pen 3, namely the line segment data.

The CPU 21, when the writing operation is finished, carries out a processing (the selection processing, see, FIG. 8) for selecting either of the save processing ((1) of FIG. 5), the addition processing ((2) of FIG. 5) and the deletion processing ((3) of FIG. 5) based on the line segment data stored in the first region in the RAM 22 (S33).

Referring not to FIG. 8, the selection processing will be described. The CPU 21 determines whether one line segment corresponding to the line segment data stored in the first region in the RAM 22 is written in the check box 123B (S81). More particularly, the CPU 21, if at least one of a plurality of pieces of coordinate data out of the line segment data indicates any position within the check region, determines the writing operation that one line segment is written in the check box 123B is being conducted (S81: YES). On the other hand, the CPU 21, if all of a plurality of pieces of coordinate data indicate positions outside the check region, determines that the writing operation that one line segment is written in the check box 123B is not being conducted (S81: NO).

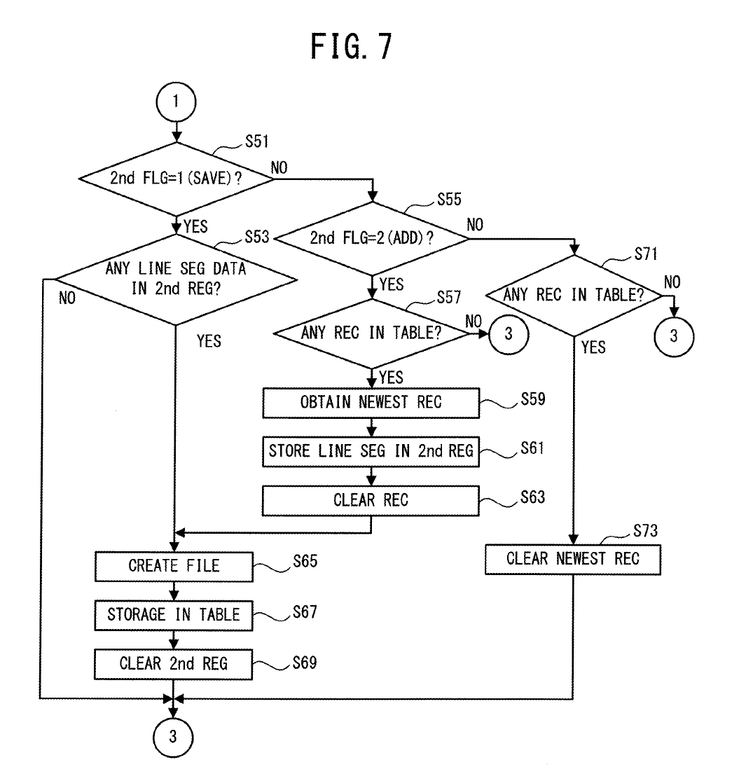

The CPU 21, if it is determined that the writing operation that one line segment is written in the check box 123B is not being conducted (S81: NO), determines that the writing operation that one line segment is written in the fillable entry region 123A is conducted. The CPU 21 then determines whether the value of the variable N is greater than “0” or “3” (S87). It should be noted that after the variable N is initialized in the processing in S13 (see, FIG. 6), if the variable N is not yet updated in the processing in S83 (to be described hereinafter), then the variable N stores “0” (S21: YES). In this case, the CPU 21 stores in the second region in the RAM 22 the line segment data stored in the first region in the RAM 22 (S89). The CPU 21 then stores in the second flag “0” indicating neither of the save processing, the addition processing and the deletion processing is to be carried out (S93). The CPU 21 then stores “0” in the variable N (S105). The CPU 21 deletes the line segment data stored in the first region in the RAM 22 (S91). The CPU 21 completes the selection processing to return to the main processing (see, FIG. 7).

On the other hand, the CPU 21, if it is determined that the writing operation that one line segment is written in the check box 123B is being conducted (S81: YES), adds “1” to the variable N (S83). The CPU 21 then stores in the second flag “0” indicating neither of the save processing, the addition processing and the deletion processing is to be carried out (S85). The reason why the second flag stores “0” regardless of that one line segment is written in the check box 123B is that two or more line segments might possibly be written in the check box 123B afterwards. The CPU 21 starts to measure the elapsed time (S86). The elapsed time to be measured indicates time elapsed from time one segment was written last time in the check box 123B. In the processing in S36 (see, FIG. 6), it is determined whether the prescribed time elapses. The CPU 21 deletes the line segment data stored in the first region in the RAM 22 (S91). The CPU 21 completes the selection processing to return to the main processing (see, FIG. 7).

As shown in FIG. 6, after the selection processing (S33) is completed, the CPU 21 determines which one out of “1” to “3” is stored in the second flag (S35). In this case, the second flag stores “0”, then CPU 21 determines that neither of the save processing, the addition processing and the deletion processing is to be carried out (S35: NO). The CPU 21 advances the processing to S36.

Next, an exemplary case will be described hereinafter where the writing operation is not conducted during the prescribed time after the writing operation writing one line segment in the check box 123B was conducted and “1” was stored in the variable N. The CPU 21 determines that the prescribed time elapses after the processing in S86 (see, FIG. 8) was carried out in the processing in S36 (S36: YES). The CPU 21 then advances the processing to S33 to carry out the selection processing (see, FIG. 8). As shown in FIG. 8, as the writing operation is not conducted, the first region in the RAM 22 does not store the line segment data. Thus, the CPU 21 determines that the writing operation writing one line segment in the check box 123B is not being conducted (S81: NO). At this moment, the variable N is not “0” and is not greater than “3” (S87: NO), rather the variable N is “1” (S95: YES), then the CPU 21 stores in the second flag “1” indicating that the save processing is to be carried out (S97). The CPU 21 stores “0” in the variable N (S105), deletes the line segment data stored in the first region in the RAM 22 (S91), and returns to the main processing (see, FIG. 6).

Next, an exemplary case will be described hereinafter where the writing operation is not conducted during the prescribed time after the writing operation that one line segment was consecutively written twice in the check box 123B was conducted. In this case, the CPU 21 twice adds “1” to the variable N to store the “2” in the variable N (S83). The CPU 21 determines that the prescribed time elapses after the processing in S86 (see, FIG. 8) was carried out in the processing in S36 (S36: YES). The CPU 21 then advances the processing to S33 to carry out the selection processing (see, FIG. 8). As shown in FIG. 8, the CPU 21 determines that the writing operation writing one line segment in the check box 123B is not being conducted (S81: NO). At this moment, the variable N is not “0” and is not greater than “3” (S87: NO), rather the variable N is “2” (S95: NO, S99: YES), then the CPU 21 stores in the second flag “2” indicating that the addition processing is to be carried out (S101). The CPU 21 stores “0” in the variable N (S105), deletes the line segment data stored in the first region in the RAM 22 (S91), and returns to the main processing (see, FIG. 6).

Next, an exemplary case will be described hereinafter where the writing operation is not conducted during the prescribed time after the writing operation that one line segment was consecutively written thrice in the check box 123B was conducted. In this case, the CPU 21 thrice adds “1” to the variable N to store the “3” in the variable N (S83). The CPU 21 determines that the prescribed time elapses after the processing in S86 (see, FIG. 8) was carried out in the processing in S36 (S36: YES). The CPU 21 then advances the processing to S33 to carry out the selection processing (see, FIG. 8). As shown in FIG. 8, the CPU 21 determines that the writing operation writing one line segment in the check box 123B is not being conducted (S81: NO). At this moment, the variable N is not “0” and not greater than “3” (S87: NO), rather the variable N is “3” (S99: NO), then the CPU 21 stores in the second flag “3” indicating that the deletion processing is to be carried out (S103). The CPU 21 stores “0” in the variable N (S105), deletes the line segment data stored in the first region in the RAM 22 (S91), and returns to the main processing (see, FIG. 6).

As shown in FIG. 6, after the selection processing (S33) is carried out, the CPU 21 determines which one of “1” to “3” is stored in the second flag (S35: YES). As shown in FIG. 7, the CPU 21 carries out either of the save processing, the addition processing and the deletion processing.

The CPU 21 determines whether the second flag stores “1” (S51). The CPU 21, when the second flag is determined to store “1” (S51: YES), carries out the save processing in the following manner. The CPU 21 determines whether at least one piece of line segment data is stored in the second region in the RAM 22 (S53). The CPU 21, when the second region in the RAM 22 is determined not to store the line segment data (S53: NO), returns to the processing in S36 (see, FIG. 6). On the other hand, the CPU 21, when the second region in the RAM 22 is determined to store at least one piece of the line segment data (S53: YES), creates the stroke data containing at least one piece of line segment data. The CPU 21 then creates an image file of an image indicating the line drawing indicated by at least one piece of line segment data contained in the created stroke data (S65). The CPU 21 specifies the creation date and time of the created image file. The CPU 21 associates the created image file with the stroke data used for creating the image file and the specified creation date and time to store them in the table 231 (S67). The CPU 21 then deletes at least one piece of the line segment data contained in the created stroke data from the second region in the RAM 22 (S69). The CPU 21 returns to the processing in S36 (see, FIG. 6).

For example, as shown in (1) of FIG. 5, when the writing operation writing one check mark in the check box 123B is conducted after the character string “ABCDE” is written in the fillable entry region 123A of the paper form 123, the stroke data containing a plurality of pieces of line segment data stored in the second region in the RAM 22 is created. Also, the image file of the image indicating the character string “ABCDE” is created based on the created stroke data (S65). A record containing the created image file is stored in the table 231 (S67). After the record is stored in the table 231, a plurality of pieces of line segment data corresponding to the character string “ABCDE” is deleted from the second region in the RAM 22 (S69).

The CPU 21, when the second flag is determined to store “2” (S52: NO, S55: YES), carries out the addition processing in the following manner. The CPU 21 determines whether at least one record is stored in the table 231 (S5). The CPU 21, when the table 231 is determined not to store the record (S57: NO), returns to the processing in S36 (see, FIG. 6). On the other hand, the CPU 21, when the table 231 is determined to store at least one record (S57: YES), obtains the record of which creation date and time is the newest out of at least one record stored in the table 231 (S59). The CPU 21 obtains at least one piece of the line segment data contained in the stroke data of the obtained record to store the line segment data in the second region in the RAM 22 (S61). The CPU 21 then deletes the record obtained in S59 from the table 231 (S63). The CPU 21 proceed to the processing in S65.

For example, as shown in (2) of FIG. 5, when the writing operation writing one check mark in the check box 123B is conducted after the character string “ABCDE” is written in the fillable entry region 123A of the paper form 123, the record containing the image file of the image indicating the character string “ABCDE” is stored in the table 231 (S67), and a plurality of pieces of the line segment data corresponding to the character string “ABCDE” are deleted from the second region in the RAM 22 (S69). Subsequently, when the character string “FGHIJ” is written in the fillable entry region 123A of the paper form 123, a plurality of pieces of line segment data corresponding to the character string “FGHIJ” is obtained and stored in the second region in the RAM 22 (S89). Yet subsequently, when the writing operation writing two line segments are written in the check box 123B (S55: YES), then a record corresponding to the character string “ABCDE” is obtained (S59). A plurality of pieces of line segment data contained in the stroke data of the obtained record are stored in the second region in the RAM 22 (S61). The second region in the RAM 22 is brought into the state that the second region stores a plurality of pieces of line segment data corresponding to the character strings “ABCDE” and “FGHIJ”. Subsequently, an image file is created based on a plurality of pieces of line segment data stored in the second region in the RAM 22 (S65). The image in the created image file contains the character strings “ABCDE” and “FGHIJ”.

The CPU 21, when the second flag is determined to store “3” (S55: NO), carries out the deletion processing in the following manner. The CPU 21 determines whether at least one record is stored in the table 231 (S71). The CPU 21, when the table 231 is determined not to store the record (S71: NO), returns to the processing in S36 (see, FIG. 6). On the other hand, the CPU 21, when the table 231 is determined to store at least one record (S71: YES), deletes the record of which creation date and time is the newest out of at least one record stored in the table 231 (S73). The CPU 21 then returns to the processing in S36 (see, FIG. 6).

For example, as shown in (3) of FIG. 5, when the writing operation writing one check mark in the check box 123B is conducted after the character string “ABCDE” is written in the fillable entry region 123A of the paper form 123, a record containing the image file of the image indicating the character string “ABCDE” is stored in the table 231 (S67). Subsequently, when the writing operation writing three check marks in the check box 123B is conducted, the record corresponding to the character string “ABCDE” is deleted from the table 231 (S73).

As shown in FIG. 6, the CPU 21, when it is determined that the data requesting command wirelessly transmitted from the smartphone 19 is received via the wireless communication portion 24 (S37: YES), wirelessly transmits the image file stored in the table 231 to the smartphone 19 via the wireless communication portion 24 (S39). The CPU 21 returns to the processing in S19.

The CPU 41 of the smartphone 19, when an operation for obtaining an image file from the reading device 2 is conducted via the touch panel 191, carries out the near field wireless communication with the reading device 2 via the wireless communication portion 44, and sends the data requesting command to the reading device 2. The image file stored in the table 231 in the flash ROM 23 of the reading device 2 is wirelessly transmitted to the smartphone 19 from the reading device 2. The CPU 41 receives the image file wirelessly transmitted from the reading device 2 to store the received image file in the flash ROM 43. The CPU 41, based on the image file stored in the flash ROM 43, allows the display 192 to display an image containing the line drawing of the same shape as the line drawing written with the electronic pen 3 on the paper form 111. It should be noted that the communication for sending the image file to the smartphone 19 from the reading device 2 is not limited to the wireless communication but may be a wired communication.

As described above, the CPU 21 of the reading device 2 selects either of the save processing (1), the addition processing (2) and the deletion processing (3) to be carried out, based on the line drawing data obtained when the line drawing is written in the check box 123B in the paper form 123 of the paper medium 100. Accordingly, the processing selected by the user can be appropriately determined to be carried out, even if a plurality of check boxes corresponding to respective processing are not provided in the paper form 111. Thus, the CPU 21 is capable of determining which processing is selected by the user and carrying out the selected processing, even if less number of check boxes are provided in the paper form 111 compared to the number of selectable processing by the user. Less number of check boxes printed on the paper form 111 allows remaining space to be a fillable entry region. Accordingly, larger fillable entry region can be reserved. As a result, the CPU 21 can efficiently suppress the fillable entry region becoming narrower, as the number of check boxes printed on the paper form 111 becoming larger.

The CPU 21, selects either of the save processing, the addition processing and the deletion processing, based on the number of line drawings written in the check box 123B. Accordingly, the user can easily instruct which processing is to be carried out from the save processing, the addition processing and the deletion processing, by adjusting the number of line drawings written in the check box 123B.

Furthermore, in the above described selection processing (see, FIG. 8), when a line drawing is not written in the check box 123B (S81: NO), then either of the save processing, the addition processing and deletion processing is selected based on the value of the variable N. Thus, for example, if a line drawing is written in the fillable entry region 123A (S81: NO) after a line drawings of which number is either of 1 to 3 is written in the check box 123B and the variable N is updated in the selection processing (see, FIG. 8) (S83), either one of the processing is selected based on the value of the variable N. Accordingly, the CPU 21 is capable of promptly identifying the number of line drawings written in the check box 123B, and determining the corresponding processing to be carried out.

It should be noted that the selection processing is also carried out when the prescribed time elapses after the line drawing was written last time in the check box 123B (S36: YES). Thus, for example, even if the writing operation is not conducted after the line drawings of which number is either of 1 to 3 is written in the check box 123B and the variable N is updated by the determining means (see, FIG. 8), an appropriate processing can be selected based on the value of the variable N. Accordingly, the CPU 21 is capable of appropriately identifying the number of line drawings written in the check box 123B, and determining the corresponding processing to be carried out.

It should be noted that the present invention is not limited to the above described embodiments but may be various modifications. In the above described addition processing, new stroke data and an image file are created based on the line drawing data contained in the stroke data of the record of which creating date and time is the newest in the table 231 and the line drawing data of newly written line drawing. Alternatively, the CPU 21 may obtain the coordinate data to be contained in the stroke data which is the basis for the image file to be newly created, from the stroke data of arbitrary record stored in the table 231. More particularly, for example, the CPU 21 may extract the coordinate data contained in the stroke data corresponding to the image file selected by the user, and add the stroke data to be newly created by writing to the coordinate data. Accordingly, new image file can be created.

In the above described embodiments, one check box 123B is printed on the paper form 123. Alternatively, two check boxes may be printed on the paper form 123. For example, the CPU 21 may carry out the save processing when a line drawing is written in one check box, otherwise may carry out the addition processing when a line drawing is written in the other check box, and may carry out the deletion processing when a line drawing is written in each of the two check boxes.

The present invention may select either of the save processing, the addition processing and the deletion processing according to different method from the selection processing (see, FIG. 8) in the above described embodiments. Hereinafter, modifications to the selection processing (i.e., a first modification and the second modification) will be described. The selection processing according to the modification is called by the processing in S33 of the main processing (see, FIG. 6). If the selection processing in the modification is to be carried out, the processing in S36 of the main processing is not carried out. Each processing of main processing other than the processing in S36 is the same as the above described embodiments. Hereinafter, the same processing as the selection processing in FIG. 8 is denoted with the same reference symbol and the description thereof will be omitted or simplified.

First Modification

The CPU 21 determines whether the writing operation writing one line segment in the check box 123B is conducted based on the line segment data stored in the first region in the RAM 22 (S81). The CPU 21, when it is determined that the writing operation writing one line segment in the check box 123B is conducted (S81: YES), calculates the duration t from the time the writing operation of one line segment corresponding to the segment data starts until the time the writing operation ends (S111). More particularly, the CPU 21 identifies the earliest time and the latest time out of a plurality of time indicated by a plurality of pieces of time data corresponding to the line segment data. The CPU 21 calculates the time from the earliest time to the latest time, as the duration t from the time the writing operation of one line segment starts until the time the writing operation ends.

The CPU 21 determines whether the duration t is smaller than 1 (one) second (S115). The CPU 21, when the duration t is determined to be smaller than 1 second (S115: YES), then stores in the second flag “1” indicating that the save processing is to be carried out (S97). The CPU 21 then deletes the line segment data stored in the first region in the RAM 22 (S91), and returns to the main processing (see, FIG. 6). On the other hand, the CPU 21, when the duration is determined to be equal to or greater than 1 second (S115: NO), determines whether the duration t is smaller than two seconds (S119). The CPU 21, when the duration t is smaller than two seconds (S119: YES), then stores in the second flag “2” indicating that the addition processing is to be carried out (S101). The CPU 21 then proceeds to the processing in S91. The CPU 21, when the duration t is equal to or greater than two seconds (S119: NO), stores in the second flag “3” indicating that the deletion processing it to be carried out (S103). Then the CPU 21 advance the processing to S91.

As described above, in the first modification, the CPU 21 selects either of the save processing, the addition processing and the deletion processing based on the duration t when the electronic pen 3 is used for writing in the check box 123B. The duration t is the time from the time a writing of a line segment which at least partially overwraps the check box 123B starts until the time the writing the line segment ends. For example, the user may allow the reading device 2 to carry out the save processing by writing the line segment quickly in the check box 123B. As such, the user may allow the reading device 2 to carry out the deletion processing by writing the line segment slowly in the check box 123B. Accordingly, the user may easily switch the processing to be carried out by the reading device 2 depending on the time of writing the line segment.

In the above described embodiments, the user may push the core body 31 of the electronic pen 3 against single point within the check box 123B. The user may also change time while the core body 31 of the electronic pen 3 being pushed depending on the processing to be carried out by the reading device 2. Even in this case, the CPU 21 may calculate the time t and select the corresponding processing based on a plurality of pieces of time data corresponding to the line segment data stored in the first region in the RAM 22.

Likewise, in the above described embodiments, the CPU 21 may blink the LED 5 at the interval of 1 second until the processing to be carried out is selected in the selection processing. The user may conduct the writing operation with the electronic pen 3 while viewing the blinking LED 5 so that the user may easily adjust the writing time that is set for the reading device 2 to carry out the desired processing to either of the duration less than 1 second (i.e., the save processing), the duration equal to or greater than 1 second and less than two seconds (i.e., the addition processing) and the duration greater than two seconds (i.e., the deletion processing).

Second Modification

The CPU 21 determines whether the writing operation writing one line segment is written in the check box 123B is conducted based on the line segment data stored in the first region in the RAM 22 (S81). The CPU 21, when it is determined that the writing operation writing one line segment is written in the check box 123B is conducted, (S81: YES), then identifies the moving direction that each of the plurality of pieces of coordinate data corresponding to the line segment data travels over time (S133). Hereinafter, the direction that each of the plurality of pieces of coordinate data travels over time is referred to as the “moving direction.” In other words, the moving direction indicates the direction that the electronic pen 3 travels when the electronic pen 3 is used for writing the line segment.

The moving direction is identified in the following manner. The CPU 21 identifies the coordinate data associated with the time data indicating the earliest time and the coordinate data associated with the time data indicating the latest time out of a plurality of pieces of coordinate data corresponding to the line segment data. Hereinafter, the position indicated by the coordinate data associated with the time data indicating the earliest time is referred to as the “starting position.” Likewise, the position indicated by the coordinate data associated with the time data indicating the latest time is referred to as the “ending position.” The CPU 21 specifies the moving direction as the rightward direction, when a length between the starting position and the ending position in the horizontal direction is equal to or greater than the prescribed value, and the ending position is located at the right side of the starting position. Likewise, the CPU 21 specifies the moving direction as the leftward direction, when a length between the starting position and the ending position in the horizontal direction is equal to or greater than the prescribed value, and the ending position is located at the left side of the starting position. Yet likewise, the CPU 21 specifies the moving direction as the downward direction, when a length between the starting position and the ending position in the vertical direction is equal to or greater than the prescribed value, and the ending position is located at the lower side of the starting position.

The CPU 21 determines whether the moving direction is the rightward direction (S135). The CPU 21, when the moving direction is determined to be the rightward direction (S135: YES), then stores in the second flag “1” indicating the save processing is to be carried out (S97). The CPU 21 then deletes the line segment data stored in the first region in the RAM 22 (S91), then return to the main processing (see, FIG. 6). On the other hand, the CPU 21, when the moving direction is determined not to be the rightward direction (S135: NO), determines whether the moving direction is the leftward direction (S139). The CPU 21, when the moving direction is determined to be the leftward direction (S139: YES), then stores in the second flag “2” indicating that the addition processing is to be carried out (S101). The CPU 21 advances the processing to S91. On the other hand, the CPU 21, when the moving direction is determined not to be the leftward direction (S139: NO), then determines whether the moving direction is to be the downward direction (S141). The CPU 21, when the moving direction is determined to be the downward direction (S141: YES), then stores in the second flag “3” indicating that the deletion processing is to be carried out (S103). The CPU 21 advances the processing to S91. On the other hand, the CPU 21, when the moving direction is determined not to be the downward direction (S141: NO), then stores in the second flag “0” indicating that neither of the saving processing, the addition processing and the deletion processing is to be carried out (S143). The CPU 21 advances the processing to S91.

As described above, in the second modification, the CPU 21 selects either of the save processing, the addition processing and the deletion processing according to the moving direction. The moving direction is the direction that the user moves the electronic pen 3 for writing the line segment. In this case, the user may switch the processing to be carried out by the reading device 2 depending on the way of writing line segment to be written in the check box.

Another modification will be described hereinafter. A part of the above described main processing may be carried out by the CPU 41 of the smartphone 19. For example, in the above described embodiments, the CPU 21 of the reading device 2 creates the image file, and the created image file is sent to the smartphone 19 in response to the request from the smartphone 19. Alternatively, the image file may be created by the CPU 41 of the smartphone 19. For example, the CPU 21, in the processing in S65, may create only the stroke data without creating the image file, and store the created stroke data in the table 231 (S67). The CPU 21, when the data requesting command is received wirelessly transmitted from the smartphone 19 (S37: YES), may send the stroke data stored in the table 231 to the smartphone 19 in the processing in S39. The CPU 41 of the smartphone 19, when the stroke data is received from the reading device 2, may create the image file based on the received stroke data. The CPU 41 may, based on the created image file, allow the display 192 to display the image containing the same shape of line drawing as the line drawing written with the electronic pen 3 in the paper form 123.

The relation between the type of processing to be carried out and either of the number of the line drawings written in the check box 123B, the writing duration, and the moving direction is not limited to the above described embodiments. For example, the CPU 21 may select either of the saving processing, the addition processing and the deletion processing to be carried out, according to the shape of line drawing written in the check box 123B.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A written data processing apparatus configured to digitize a movement trajectory of a writing instrument when the writing instrument is used to write on a located paper medium, comprising:
a detection portion configured to detect a position of the writing instrument in proximity to a prescribed region in which the paper medium is to be located; and
a processor configured to:
obtain coordinate data corresponding to a position detected by the detection portion, and obtain time data corresponding to obtaining time when the coordinate data is obtained;
determine whether a first position specified by the obtained coordinate data and a second position within a check region coincides with each other or not, the check region being at least one region determined based on a type of the paper medium out of the prescribed region;
store, when the first position and the second position are determined not to coincide, the coordinate data and the time data in a first storage portion;
select, when the first position and the second position are determined to coincide with each other, either of a save processing, an addition processing, and a deletion processing based on at least either of the coordinate data and the time data;
create, when the save processing is selected, a first image file containing a dot or a line drawing indicated by the coordinate data stored in the first storage portion, and store the created first image file in a second storage portion;
create, when the addition processing is selected, a second image file containing a dot or a line drawing indicated by the coordinate data corresponding to the first image file stored in the second storage portion and a dot or a line drawing indicated by the coordinate data stored in the first storage portion, and storing the created second image file in the second storage portion as the first image file; and
delete, when the deletion processing is selected, the first image file from the second storage portion.

2. The written data processing apparatus according to claim 1, wherein determining whether the first position and the second position coincide with each other is determined by determining whether the first position coincides with any position within the check region.

3. The written data processing apparatus according to claim 1, wherein the processor is further configured to:
calculate a number of at least one dot or line drawing indicating a trajectory of a position of the writing instrument traveling in proximity to the prescribed region based on at least one piece of the coordinate data and at least one piece of the time data; and
select either of the save processing, the addition processing and the deletion processing based on the calculated number.

4. The written data processing apparatus according to claim 1, wherein the processor is further configured to:
calculate duration in a state where the writing instrument is in proximity to the prescribed region based on the time data; and
select either of the saving processing, the addition processing and the deletion processing based on the calculated duration.

5. The written data processing apparatus according to claim 1, wherein the processor is further configured to:
identify a moving direction that the writing instrument travels in a state where the writing instrument is in proximity to the prescribed region based on the coordinate data and the time data; and
select either of the saving processing, the addition processing and the deletion processing based on the identified direction.

6. The written data processing apparatus according to claim 1, wherein selecting either of the saving processing, the addition processing and the deletion processing is carried out based on the coordinate data obtained during time from time the coordinate data coinciding with any position within the check region is obtained until time the coordinate data coinciding with none of positions within the check region is obtained out of the obtained coordinate data.

7. A written data processing apparatus configured to digitize a movement trajectory of a writing instrument when the writing instrument is used to write on a located paper medium, comprising:
a detection portion configured to detect a position of the writing instrument in proximity to a prescribed region in which the paper medium is to be located; and
a processor configured to:
obtain coordinate data corresponding to a position detected by the detection portion, and obtain time data corresponding to obtaining time when the coordinate data is obtained;
determining whether a first position specified by the obtained coordinate data and a second position within a check region coincides with each other or not, the check region being at least one region determined based on a type of the paper medium out of the prescribed region;
store, when the first position and the second position are determined not to coincide, the coordinate data and the time data in a first storage portion;
select, when the first position and the second position are determined to coincide with each other, either of a save processing, an addition processing, and a deletion processing based on at least either of the coordinate data and the time data;
create, when the save processing is selected, a first stroke data based on the coordinate data stored in the first storage unit, and stores the created first stroke data in a second storage unit;
create, when the addition processing is selected, a second stroke data based on the coordinate data corresponding to the first stroke data stored in the second storage unit and the coordinate data stored in the first storage unit, and store the created second stroke data in the second storage unit as the first stroke data; and
delete, when the deletion processing is selected, the first stroke data from the second storage unit.
